(19) United States
(12) Patent Application Publication
(10) Pub. No.: US 2010/0021721 A1
(43) Pub. Date: Jan. 28, 2010

(54) Composite material and method for the production of a composite material

(75) Inventor: Andreas Werler, Zwickau (DE)

Correspondence Address: COLLARD & ROE, P.C., 1077 NORTHERN BOULEVARD, ROSLYN, NY, 11576, US

(73) Assignee: IAV GmbH Ingenieurgesellschaft Auto und Verkehr

(21) Appl. No.: 12/220,177

(22) Filed: Jul. 22, 2008

(51) Int. Cl. B32B 15/04; B32B 18/00; B22D 11/00

(52) U.S. Cl. 428/325; 428/457; 428/337; 164/1

(57) ABSTRACT

A composite material and a method for the production of a composite material, in which the composite material has steel-like properties, at an increased modulus of elasticity, and a lower weight, and which can be produced in cost-advantageous manner. The composite material consists of ceramic particles, which are completely or partially sheathed with a metallic material, and partially or completely embedded in a metallic casting material. According to the method, ceramic particles are sheathed with a metallic material, and the ceramic particles sheathed in this manner are either embedded in a metallic casting material or sintered to form a steel matrix, which can also be embedded in a metallic casting material, if necessary.

### BACKGROUND OF THE INVENTION

1. Field of the Invention

The invention relates to a composite material as well as to a method for the production of a composite material.

2. The Prior Art

Composite materials are combinations of at least two different materials, with the goal of improving the material properties of the individual substances by means of the combination of materials.

It is known to produce composite bodies of ceramic and metal, in order to combine the properties of the materials, such as the hardness of the ceramic and the deformability of the metal, with one another. In this connection, a molten metal is embedded into a ceramic body (see German Publication Nos. DD 301 900 A9, DD 285 774 A5, and International Application Publication No. WO 92/00256 A2). German Patent No. DE 37 86 163 T2 describes a method for the production of ceramic/metal composite materials, in which the starting substances, in powder form, pass through a sintering process.

A metal/ceramic composite material is described in German Patent No. DE 10 2004 012 990 A1, which consists of an open-pore metal foam, and whose pores are completely or partially filled with a ceramic material. The composite material has a great hardness and great impact resistance, at a comparatively low weight.

From German Patent No. DE 10 2004 063 489 B3, it is known to form light-construction elements on the basis of hollow spheres, in which the hollow spheres are precisely placed in accordance with the part to be produced, by means of a feed device, and connected with one another by means of pressing or heating (see also German Patent No. DE 100 18 501 C1). In accordance with German Patent No. DE 199 29 760 C2, the metallic or ceramic hollow spheres consist of different material layers.

The disadvantage of the known methods consists in the fact that the production of a composite material that has low weight and great hardness and impact resistance is very complicated. It is true that the weight of the material is reduced by means of the use of hollow spheres or metal foam, but the hardness and impact resistance of the material, on the whole, are not satisfactory.

### SUMMARY OF THE INVENTION

It is therefore an object of the invention to provide a composite material and a method for the production of a composite material, in which the composite material has steel-like properties, at an increased modulus of elasticity, and a lower weight, and which can be produced in cost-advantageous manner.

This task is accomplished, according to the invention, by a composite material consisting of a ceramic material made of ceramic particles, which is completely or partially sheathed with a metallic material, and partially or completely embedded in a metallic casting material.

The material according to the invention has steel-like properties but with an increased modulus of elasticity. The pressure forces that act on the material are absorbed by the brittle and solid ceramic material, while the steel matrix that surrounds the ceramic material absorbs the tensile forces that act on the material.

In one embodiment, the casting material can be a casting steel or casting iron, and/or the material that sheathes the ceramic particles can be steel. The embedded ceramic particles preferably possess a material grain size of 0.1 mm to 10 mm.

In one embodiment, the ceramic material is Al₂O₃. In another embodiment, the steel coating of the ceramic particles amounts to a thickness of 2 μm to 3 mm.

In another embodiment, the proportion of the ceramic material in the composite material amounts to 30% to 90 M-%, preferably 55% to 65-%. The ceramic particles to be sheathed are preferably almost spherical.

According to the method according to the invention, ceramic particles are sheathed with a metallic material, and the ceramic particles sheathed in this manner are either embedded in a metallic casting material or sintered to form a steel matrix, which can also be embedded in a metallic casting material, if necessary.

The small-grain ceramic particles are preferably sheathed with a metallic material by means of a spraying method or by means of granulation in a fluidized bed. In one embodiment, the ceramic particles, which preferably consist of Al₂O₃ and have a material grain size of 0.1 mm to 10 mm, are sheathed with a metallic material.

In another embodiment, the ceramic particles are completely or partially sheathed with a steel layer. In another embodiment, the sheathed ceramic particles are sintered together to form a steel matrix, which has a thickness of preferably 2 μm to 3 mm. The sheathed ceramic particles or the parts sintered together to form a steel matrix can have a metallic casting material such as casting steel or casting iron cast around them.

Preferably, the ceramic particles have a metallic casting material cast around them in such a manner that the proportion of the ceramic material in the composite material amounts to 30% to 90 M-%, preferably 55% to 65 M-%.

Another significant advantage of the solution according to the invention is that the material is lighter, on the whole, than a comparable steel material, and furthermore has an increased modulus of elasticity.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of the composite material according to the invention; and

FIG. 2 shows the strength/expansion diagram, shown as an example for a tensile test of the composite material according to the invention in comparison with a ceramic material and a steel material.

### DETAILED DESCRIPTION OF THE PREFERRED EMBODIMENT

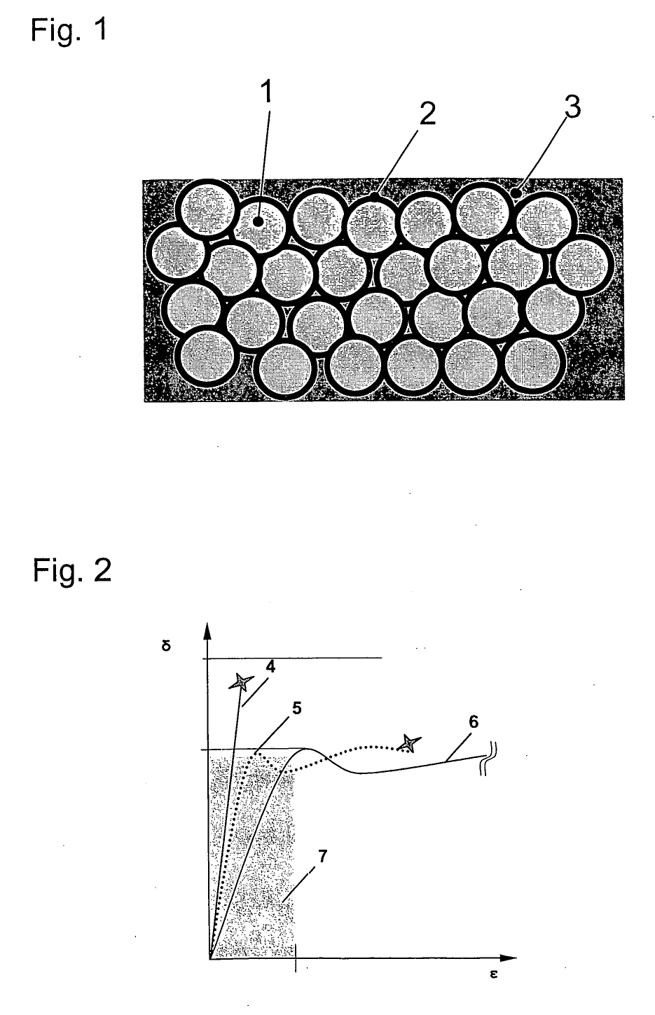

The composite material according to FIG. 1, consists of ceramic particles 1 completely or partially sheathed with a metallic material 2, which particles are partially or completely embedded in a metallic casting material 3. In this connection, small-grain, preferably spherical ceramic particles 1 are completely or partially sheathed with a metallic material, by a method such as a spray method or by means of granulation in a fluidized bed, for example. A spherical shape of the ceramic particles 1 is preferred, in order to avoid the risk of cracks of the ceramic particles 1 embedded in the casting material 3 under material stress. Ceramic particles 1 possess a material grain size of 0.1 to 10 mm, and consist of Al₂O₃. In accordance with the material size of ceramic particles 1, these are sheathed with a metallic material 2, whose coating thickness can amount to approximately 2 μm to 3 mm. Sheathing of the ceramic particles 1 preferably takes place with a steel layer 2. In this connection, the surface roughness of the spherical ceramic particles 1 is selected in such a manner that good adhesion of the steel layer 2 to the surface of the ceramic particles 1 is guaranteed.

Furthermore, when sheathing the ceramic particles 1, attention must be paid to ensure that the casting material, the sheathing material, and the ceramic material possess approximately the same heat expansion coefficient.

According to the invention, sintering of steel sheathings 2 of ceramic particles 1 with one another takes place in a further step, at appropriate temperatures, whereby the steel matrix formed in this manner already corresponds to the basic shape of the parts to be produced. The steel matrix that is sintered together, with the enclosed ceramic particles 1, is brought into its final shape by means of casting a metallic casting material 3 around it, whereby this molded piece can certainly be mechanically processed further. In this connection, the mechanical processing represents a significant advantage of the composite material according to the invention. Casting steel or casting iron is used as the casting material 3, for example.

The material produced in this manner has steel-like properties, but possesses an increased modulus of elasticity and is lighter as compared with pure steel material. As a result, there is an increased area of use in technology, particularly in motor vehicle technology. FIG. 2 shows a corresponding strength/expansion diagram, in which the strength of the material, in each instance, was plotted with δ and the expansion with ε. In FIG. 2, the expansion curve of steel was recorded as 6, and that of ceramic as 4. The curve 5 shows a tendentially possible progression of the expansion curve of the composite material according to the invention, consisting of a steel/ceramic matrix, in accordance with the material composition selected. From this, it is evident that the composite material has an increased modulus of elasticity as compared with steel, but has approximately the same expansion progression as steel. As compared with the pure ceramic material, the composite material produced according to the invention has significantly better expansion properties. In FIG. 2, the elastic range of steel is shown with 7. It is possible to adjust the impact strength, i.e. the modulus of elasticity of the composite material by means of different material thicknesses of the sheathing 2 of the ceramic particles 1, and by means of the total proportion of metallic material in the composite material. In the case of corresponding stress on the component, tensile forces that are introduced are mainly absorbed by the steel matrix, and pressure forces that are introduced are mainly absorbed by the ceramic material. According to the invention, the proportion of the ceramic material in the composite material amounts to approximately 30% to 90 mass-%, preferably 55% to 65 mass-%.

A variant of the solution according to the invention provides for providing the ceramic particles 1 sheathed with a steel layer 2 with a surrounding casting structure by means of a casting material 3, without first sintering them with one another.

Another possibility consists in producing the final shape only by means of sintering together the sheathed ceramic particles 1. In this connection, casting a casting material 3 around the steel-sheathed ceramic particles 1 that have been sintered to one another is not required.

Accordingly, while only a few embodiments of the present invention have been shown and described, it is obvious that many changes and modifications may be made thereunto without departing from the spirit and scope of the invention.

### LIST OF REFERENCE SYMBOLS USED

1 ceramic particle
2 material of the sheathing of the ceramic particles
3 basic material
4 expansion curve of ceramic
5 expansion curve of the steel/ceramic composite material
6 expansion curve of steel
7 elastic range of steel
δ strength
ε expansion

What is claimed is:

1. A composite material consisting of ceramic particles completely or partially sheathed with a metallic material, said ceramic particles being partially or completely embedded in a metallic casting material.

2. The composite material according to claim 1, wherein the casting material is a casting steel or casting iron.

3. The composite material according to claim 1, wherein the material that sheathes the ceramic particles is steel.

4. The composite material according to claim 1, wherein the embedded ceramic particles possess a material grain size of 0.1 mm to 10 mm.

5. The composite material according to claim 1, wherein the ceramic material is Al₂O₃.

6. The composite material according to claim 1, wherein the metallic material sheathing the ceramic particles is steel having a thickness of 2 μm to 3 mm.

7. The composite material according to claim 1, wherein a proportion of the ceramic particles in the composite material amounts to 30% to 90 M-%.

8. The composite material according to claim 1, wherein the ceramic particles to be sheathed are almost spherical.

9. A method for the production of a composite material of ceramic and a metallic material, comprising the following steps:
sheathing the ceramic particles with a metallic material; and
casting a metallic casting material around the sheathed ceramic particles.

10. The method according to claim 9, wherein the ceramic particles are sheathed with a metallic material by means of a spraying method or by means of granulation in a fluidized bed.

11. A method according to claim 9, wherein the ceramic particles consist of Al₂O₃, and have a material grain size of 0.1 mm to 10 mm.

12. A method according to claim 9, wherein the metallic material sheathing the ceramic particles is steel.

13. The method according to claim 9, wherein the sheathed ceramic particles are sintered together to form a steel matrix.

14. The method according to claim 13, wherein the parts sintered together to form a steel matrix have a metallic casting material cast around them.

15. The method according to claim 9, wherein the metallic casting material is casting steel or casting iron.

16. The method according to claim 9, wherein the ceramic particles are sheathed with a steel matrix having a thickness of 2 μm to 3 mm.

17. The method according to claim 9, wherein the ceramic particles have a metallic casting material cast around them in such a manner that the proportion of the ceramic particles in the composite material amounts to 30% to 90 M-%.
